(19) United States
(12) Patent Application Publication
(10) Pub. No.: US 2003/0226069 A1
(43) Pub. Date: Dec. 4, 2003

(54) Test administration platform

(76) Inventor: Michael E. Legatt, White Plains, NY (US)

Correspondence Address: ROBERT S. STOLL, STOLL, MISKIN, HOFFMAN & BADIE, 4710 Empire State Building, New York, NY, 10118, US

(21) Appl. No.: 10/449,052

(22) Filed: May 30, 2003

Related U.S. Application Data
(60) Provisional application No. 60/384,479, filed on May 31, 2002.

(51) Int. Cl. H02H 3/05; G06F 7/00

(52) U.S. Cl. 714/46; 707/104.1

(57) ABSTRACT

The invention, named Test Administration Platform (TAP), comprises a software language and method and means for the development and administration of tests based on an open-source proprietary programming language, and for the storage of these test results in a searchable and exportable database. While intended initially for use in the field of neuropsychology, the invention has utility in many fields, particularly in research fields in which intermediate data might be useful. The invention can also be used to store free-form data, such as interview notes and demographic data. All data within the invention is organized by subject. Tests utilizing the invention can be administered on personal computer and personal digital assistant (PDA) platforms, and can use one or two displays. The invention provides that tests created with the invention and data created during administration of the tests can synchronize and backup to a central server using wireless or wired networking technologies, and can take advantage of text-to-speech, audio recording and tablet/touch-screen recording technologies.

### CROSS-REFERENCE TO RELATED APPLICATION

This application claims the benefit of U.S. Provisional Patent Application No. 60/384,479, filed May 31, 2003 by Michael E. Legatt.

### TECHNICAL FIELD OF THE INVENTION

This invention relates to the field of computer-based testing methodology and means including computer language for creation and administration of the testing methodology.

### BACKGROUND OF THE INVENTION

In the field of Neuropsychology (as well as in many others), several tests/measures are administered using pen-and-paper methods and computer methods. There is currently no universal design environment for such tests, nor a universal administration method that would allow test to be administered on Personal Digital Assistants (PDAs). Computer/PDA test administration has several advantages over pen-and-paper methods. Often, the amount of time a subject takes to answer a question, or the number of times a subject will change his mind before moving to the next question is of clinical relevance. Many tests rely on iterative decisions based on previous responses (during a test administration, questions and modules will often be skipped or expanded based on previous responses). These decision patterns often make administration difficult, requiring manuals in parallel with administration sheets. Furthermore, the grading of these exams requires accessing several norms and equivalency tables based on demographic information; often, either individual responses or global scores are ignored and undocumented in favor of the other. As pen-and-paper data is often uncoded or partially coded, a great deal of data is lost, or a great amount of time is expended retroactively coding data for research purposes.

### BRIEF SUMMARY OF THE INVENTION

The Test Administration Platform (TAP) of the invention would attempt to unify all of these tests, by providing a design environment that would allow tree-structure design of a test, test administration on a PDA or on a computer, scoring of that test directly on that PDA or computer, and storage of individual responses (answers, timing and other useful data) in the PDA or computer. A test conducted in accordance with the invention can be administered either directly to the subject or through the practitioner, depending how the test is designed.

There are existing technologies to administer particular neuropsychological tests on computer systems, but they are proprietary closed systems. There is no sharing of demographic data, for example, between these systems, nor a uniform way to export or analyze data beyond the scope of the preprogrammed measures of that program. The invention aims to create an open system that will allow for ease of data storage, retrieval and analysis. Furthermore, the invention can be used to develop “helper applications”, which function to electronically collect testing data or score data, allowing pen-and-paper uses to be phased out. Similarly, the invention allows for integration of free-form data, such as interview and psychotherapy notes, all of which can be uniformly accessed by individual.

### BRIEF DESCRIPTION OF THE DRAWING

FIG. 1 is a screen shot image showing the window utilized in constructing the test in accordance with the invention from the various selections presented.

FIG. 2 is a representation of the tester's screen image of a test constructed and being performed in accordance with the invention, such image including showing what is on the screen of the test subject.

### DETAILED DESCRIPTION OF THE INVENTION

The invention comprises a proprietary language and platform developed for use both as an aid to neuropsychological test administration, and in certain cases, a means to directly administer a neuropsychological measure or test regime. It is not intended to replace a tester-to-subject interaction, rather to improve the efficiency of that interaction so that the tester is better able to store and analyze data and better make and record observational data of the testing session. It is a tool intended for use in research, as it allows for spontaneous coding of both overall test scores and individual responses. It is also intended for clinical use, with a subject management tool, able to store and integrate any form of data.

The invention's language allows for testing protocols to be developed both where the tester is using a computer or portable device (e.g. Palm PDA) to record data, and where the subject is directly using such a device. The protocol also allows for dual-monitor systems to be used, so that both tester and subject can see different screens, or different images on the same screen but at different times, the subject with the stimuli and the tester with the stimuli, relevant norm information, and other relevant data. This dual-monitor configuration can be used either on a computer with two monitors (with touch-screen support for one and/or both), and for a PDA with an external monitor (such as a Palm PDA with Margi's Presenter-to-go external monitor/projector system). The invention is also able to use text-to-speech programs to administer questions to those with vision and/or reading difficulties. The invention includes support for the VFS (virtual file system) of the Palm OS™ platform, allowing for unlimited data storage across secure digital (SD), multimedia card (MMC), CompactFlash (CF) and/or memory stick (MS) devices. The invention is cross-platform compatible, and designed to run on PDAs only on removable media, so that security requirements for subject confidentiality involve only removing and securely storing a removable media card.

The invention's language also includes statistical conversions of raw data into standard scores, including the use of norms tables and statistical transformations which can be custom-programmed (e.g. standard score ->T-score ->z-score). It also allows for continuous updating to a central server using wireless technologies such as Bluetooth™ or 802.11 when testing on remote laptop or PDA platforms, to minimize chances of data loss.

While the invention has originally been developed for neuropsychological testing, its flexible interface allows for use in almost any realm in which data collection and/or analysis is conducted. It could just as easily be used for psychotherapeutic interventions, both in maintaining session logs, patient contact information, payment information, and relevant checklists for maintaining progress throughout the therapeutic process. A major advantage of this integration is the minimal effort that is required to import data into statistical analysis packages such as SAS or SPSS, enabling a researcher to choose any data points for analysis, rather than merely looking at overall scores or having to expend a great deal of time entering item data.

The test design allows for construction of variables (which can have values assigned to them during the administration of the test, have random values assigned, or preassigned values). Variables can also be assigned types, such as dates, integers, strings, etc. Norm Tables are constructed within the invention, or can be imported from other sources. Preassigned sounds and images can be scanned, recorded and downloaded into the program.

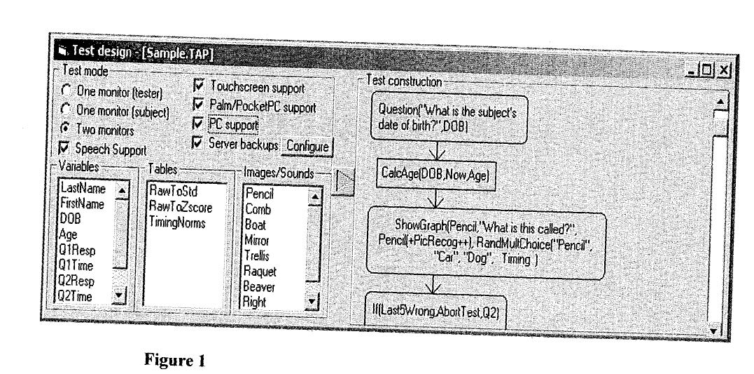

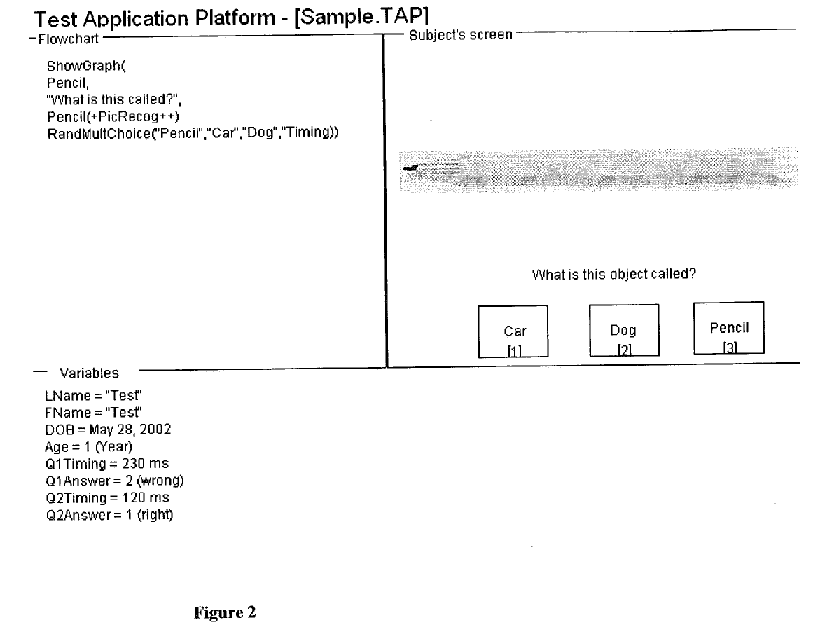

With reference to the drawing, FIG. 1 is a sample screen for the invention's test development environment. Variables, tables, images and sounds can be created and stored within the environment. On the right-hand side of the window, the flowchart is being developed for this sample TAP. The procedures displayed on the screen will query the subject's birthday, calculate the subject's age, show a stored image (the pencil), and ask the subject to choose from one of three answers, “Pencil”, “Car”, and “Dog”. The image in FIG. 2 is a sample of what this question would look like on the tester's computer screen, with the current command in the top-left window, a view of the subject's computer screen in the top-right, and information on all of the collected variables in this test.

Currently, the language of the invention supports the following commands:

Question(QuestionText, VariableToStore)—Pose the subject a question, and store the response in VariableToStore.

CalcAge(DateOfBirth, CurrentDate, VariableToStore)—Calculate a subject's age as of CurrentDate based on DateOfBirth, and store in VariableToStore. If VariableToStore is a date, then the age will be stored as year/month/day. If it is an integer, then the age will be stored in years.

ShowGraph(Image, QuestionText, HandleResponse, Options, [RespTime])—Shows the graphic Image and administers QuestionText with it. Options contains the responses, the first of which is the correct answer. If the answers are given with the operator RandMultChoice, the responses will be administered in random order. If requested, the amound of time (in milliseconds) will be stored in RespTime.

PlaySound(Sound, QuestionText, HandleResponse, Options, [RespTime])—This is similar to ShowGraph, except it will either play Sound if sound is an audio file, or use a text-to-speech module if Sound is text.

WriteText(Text, Location/Size, Font, [Command])—Writes Text to the screen, in Location/Size (for example, CenterMax will draw the text in the center of the screen as large as possible to maintain the text within the screen boundaries.). Optionally, after drawing the text (or speaking the text if requested), [Command] will be executed.

If (Condition, IfTrue, IfFalse)—Standard If—>Then—>Else handling.

TrapKey (KeyCode/Anykey, TimeOut, [VariableToStore], [Command])—Waits for a particular key, or any key within a certain amount of time (TimeOut−0 is unlimited). Optionally, it will store the response in VariableToStore and/or the time to the response in TimeToStore, and execute [Command] when a response or timeout occurs.

Wait (TimeOut)—Wait for a preset amount of time.

There are several custom operators to allow aborting administration, such as Last3Wrong, Last4Wrong, Last5Wrong, Last4in6Wrong, etc. These operators allow for flow control of the program.

RecordWriting(Prompt, VariableToStore)—Prompts the subject to draw something on the screen, and records it to a timed-vector image (an image file containing both the time (in milliseconds) in which a line/dot is drawn, and the destination of that line)

EnableSubjectScreen/DisableSubjectScreen—In a two-monitor setup, determine whether the subject's screen is blank, and whether graphics, text and questions appears on the subject screen.

RunTAP (VariablesToPass)—Executes another TAP configuration stored on the portable device or laptop. When that configuration is complete, the calling TAP continues form the following command.

EndTap—End the currently-executing TAP configuration.

It is anticipated that the language will expand with additional commands.

It will therefore be seen that the invention comprises computer means for creating and administering measures or test regimes including programming language means adapted to permit creation of at least one test regime, means adapted to permit such test regime to be administered to at least one subject and means adapted to evaluate test results. The invention includes platform means capable of running the programming language means, dual computer display means, having at least one display screen operatively connected to the platform means and adapted to display both tester screen images and test subject screen images, generally alternately so that the test subject can take the test and turn the display back to the test administrator for review. This mode would conveniently apply to a portable device taken to the subject by the administrator. The platform means may have a plurality of display screens adapted to selectively display said tester screen images and said test subject screen images, a mode useful when there are a plurality of subjects simultaneously taking the test regime and one administrator supervising.

Evaluation of the test results by marking answers as right or wrong is but one of the several characteristics the invention is enabled to provide. Other characteristics include the time it takes a subject to answer a question, the average time for answering all questions, repeated wrong answers, repeated attempts to answer but missing the screen area designated for entering an answer, and other characteristics applicable to the type of test being administered.

While the foregoing is illustrative of a preferred embodiment of the invention, other embodiments and modifications and improvements are intended to come within the scope of the invention and of the appended claims.

What is claimed is:

1. Computer means for creating and administering test regimes comprising:
a. programming language means, said programming language means comprising means adapted to permit creation of at least one test regime, means adapted to permit such test regime to be administered to at least one subject and means adapted to evaluate test results;
b. platform means, said platform means comprising computer means capable of running said programming language means;
c. dual computer display means, said dual computer display means comprising at least one display screen operatively connected to said platform means and adapted to display both tester screen images and test subject screen images.

2. Computer means for creating and administering test regimes in accordance with claim 1, wherein said dual computer display means comprises at least one display screen adapted to selectively display said tester screen images and said test subject screen images.

3. Computer means for creating and administering test regimes in accordance with claim 1, wherein said dual computer display means comprises a plurality of display screens adapted to selectively display said tester screen images and said test subject screen images.

4. Computer means for creating and administering test regimes in accordance with claim 1, wherein said platform means comprises operatively connected separate computer means adapted for creation of test regimes and computer means adapted for administering said test regimes.

5. Computer means for creating and administering test regimes in accordance with claim 1, wherein said means adapted to evaluate test results comprises means adapted to record characteristics of the answers.

6. A method for creating and administering test regimes, comprising the steps of:
a. providing computer programming language means adapted to create test regimes,
b. adapting said computer programming language means to administer test regimes,
c. further adapting said computer programming language means to record characteristics of the responses to said test regime.
